(19) United States
(12) Patent Application Publication
(10) Pub. No.: US 2006/0104056 A1
(43) Pub. Date: May 18, 2006

(54) Hands free light harness and switch assembly

(75) Inventors: Thomas L. O'Brien, Crown Point, IN (US); Douglas J. Korslund, Riverside, IL (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Thomas L. O'Brien, Crown Point, IN (US)

(21) Appl. No.: 11/270,172

(22) Filed: Nov. 9, 2005

Related U.S. Application Data
(60) Provisional application No. 60/627,702, filed on Nov. 12, 2004.
(60) Provisional application No. 60/627,702, filed on Nov. 12, 2004.

(51) Int. Cl. B60Q 1/26

(52) U.S. Cl. 362/227

(57) ABSTRACT

A hands free light assembly is disclosed. The assembly comprises a circuit including a plurality of LED's, a battery connector and a conductor electrically coupling the battery connector to the LED's. The assembly further comprises a connecting device for removably connecting the circuit to a hand.

### CROSS-REFERENCE TO RELATED APPLICATION

This application claims priority of U.S. provisional patent application Ser. No. 60/626,125, filed Nov. 9, 2004, and U.S. provisional patent application Ser. No. 60/627,702, filed Nov. 12, 2004.

### FEDERALLY SPONSORED RESEARCH OR DEVELOPMENT

Not Applicable.

### TECHNICAL FIELD

This invention generally relates to a hands free light harness having a novel switch assembly, such as for use as a signaling device by railroad workers.

### BACKGROUND OF THE INVENTION

Often individuals are hampered or restricted in their work efforts because of improper illumination. It may occur when a shadow is present; it may occur because of restricted work space or just poorly directed light sources. Typical victims include mechanics, electricians, technicians, emergency workers, doctors and dentists.

In the railroad industry, workers use railroad lanterns, flags and fuses for signaling purposes. Lanterns and fuses are typically used during the dark hours of the day. The typical lantern is handheld and weighs about four to five pounds. Switchmen and brakemen use this lantern to indicate to the engineer their desire to move trains in one direction or another. In the process of doing so, these employees are required to, as part of their duties, mount and dismount moving equipment while holding their lanterns. This can be quiet cumbersome when the employee is also trying to talk on the radio, and handle a switch list at the same time.

The idea of having a light mounted to your person and still having full use of one's hand is a safety improvement which should be of interest to those of all industries. The advantages of hands free mounted lights is an idea that will be useful and apparent to many for a multitude of reasons.

The present invention is provided to address this and other issues.

### BRIEF DESCRIPTION OF THE DRAWINGS

FIG. 1 is a view of one embodiment of the invention;

FIG. 2 is a view of a second embodiment of the invention;

FIG. 3 is a view of a battery connector/switch as utilized by the first two embodiments of the invention.

FIG. 4 is a plan view of a third embodiment of the invention; and

FIG. 5 is a side view of the third embodiment of the invention.

### DETAILED DESCRIPTION OF THE INVENTION

While this invention is susceptible of embodiment in many different forms, there will be described herein in detail, specific embodiments thereof with the understanding that the present disclosure is to be considered as an exemplification of the principles of the invention and is not intended to limit the invention to the specific embodiments illustrated.

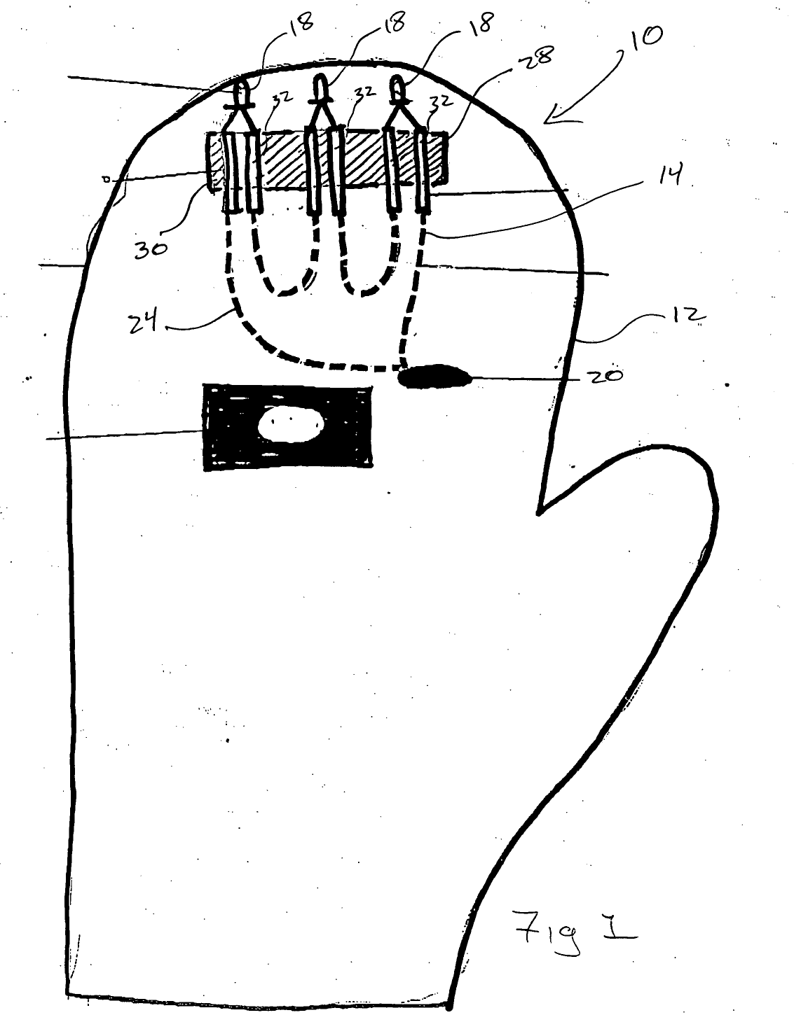

A first embodiment of a hands free signaling system 10 in accordance with the invention is illustrated in FIG. 1. The signaling system 10 comprises a hand covering 12 adapted to be placed over a hand. In the first embodiment, the hand covering 12 is in the form of a mit.

The signaling system 10 further includes a harness 14 including a plurality of LED's 18, a battery connector 20 and a wire harness 24 electrically coupling the battery connector 20 to the LED's 18. The LED's 18 may be white and/or colored. The signaling system 10 also includes a connecting device 28 for removably connecting the harness 24 to the hand covering glove 12.

In the first embodiment, the connecting device comprises a first side 30 of a hook and loop fastener secured to the hand covering 12 and a plurality of second sides 32 of the hook and loop fastener secured to each of each of the LED's 18.

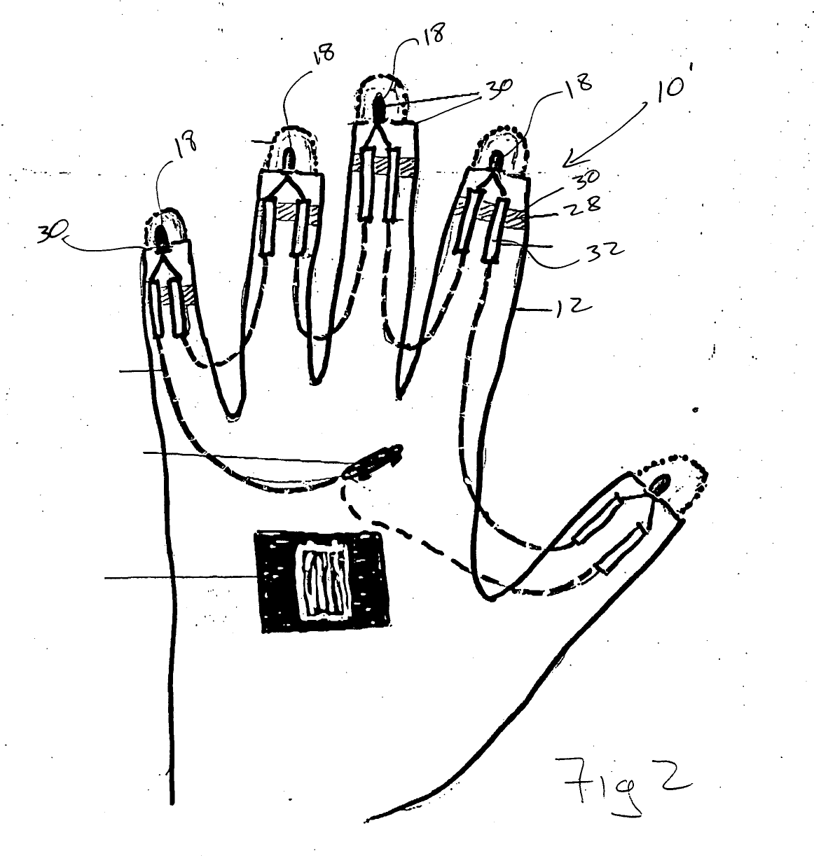

A second embodiment of the signaling system 10′ is illustrated in FIG. 2. In the second embodiment, the hand covering 12 is in the form of a glove with open fingers tips for improved dexterity. In the second embodiment, there is one LED 18 associated with each finger of the hand.

The battery may also be secured to the hand covering by a hook and loop fastener.

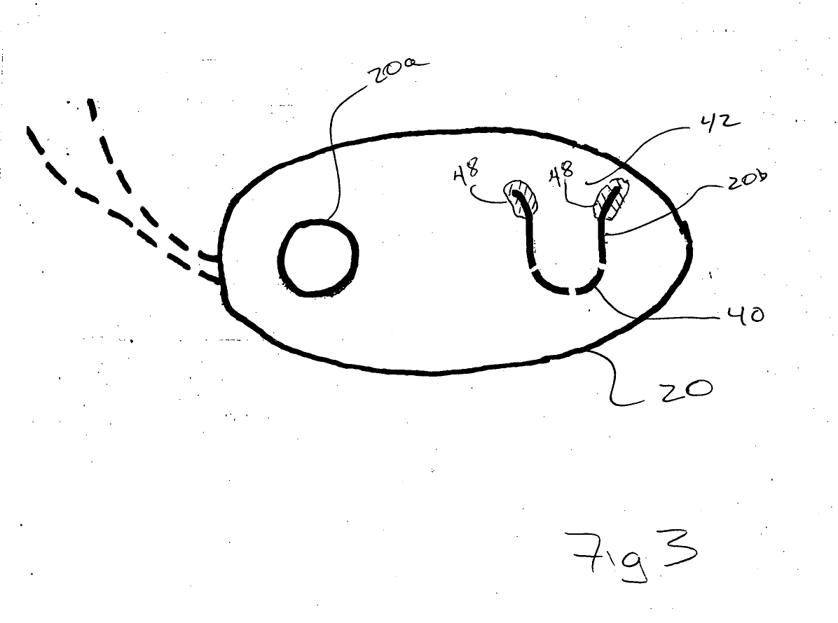

The battery connector 20 is illustrated in greater detail in FIG. 3. The battery connector 20 has a male snap connector 20a and a female snap connector 20b to connect with corresponding female and male snap connectors of a conventional 9 volt battery. The female connector 20b of the battery snap connector 20 has a generally circumferential lip 40 having a lip gap 42 to permit the male snap connector of the battery to radially disengage from the female snap connector 20b of the battery connector 20, operating as a switch to decouple the battery from the assembly. The battery may be secured to the glove such as by a hook and loop fastener.

Ends of the lip 40 may be coated or otherwise covered with an electrical insulator 48, such as rubber, so that the male snap connector of the battery will only electrically contact the female snap connector 20b of the battery connector 20 when fully seated in the female snap connector 20b, thus preventing accidental illumination.

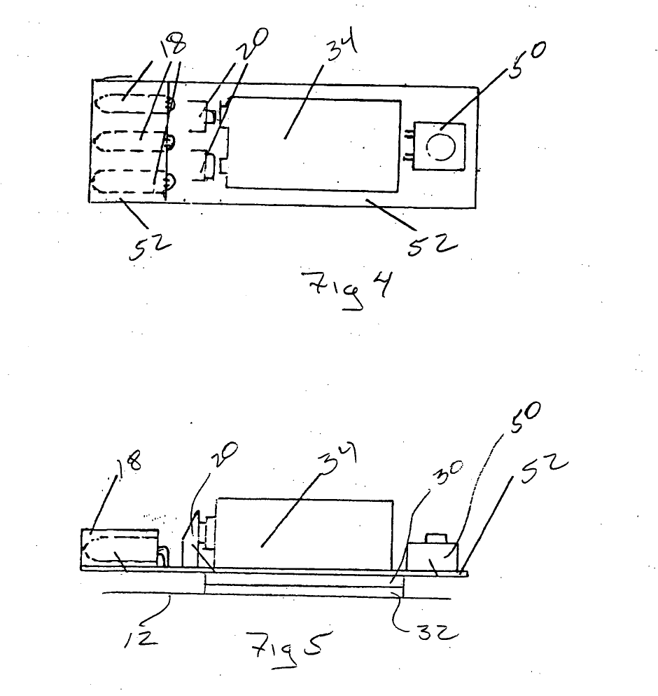

A third embodiment of the signaling system 10″ is illustrated in FIGS. 4 and 5. The signaling system 10″ includes three LED's 18, a battery connector 20 and a push-button switch 50 mounted on a printed circuit board 52. Conventional conductive tracks on the underside of the printed circuit board 52 electrically couple the components to form a circuit to illuminate the LED's 18. The signaling system 18″ is connected to the back-side of a hand covering 12 by the first side 30 of a hook and loop fastener, the back side of the hand covering 12 having the second side 32 of the hook and loop fastener.

Thus each of the embodiments permits easy attachment to, and removal from, the hand covering.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

What is claimed is:

1. A hands free light assembly comprising:
a circuit including a plurality of LED's, a battery connector adapted to receive a battery, and a conductor electrically coupling the battery connector to the LED's; and
a connecting device for removably connecting the circuit to a hand.

2. The assembly of claim 1 wherein the connecting device comprises a first side of a hook and loop fastener.

3. The assembly of claim 2 wherein the connecting device further comprises a second side of the hook and loop fastener secured to a glove adapted to be placed over the hand.

4. The assembly of claim 3 including a plurality of the second sides of the hook and loop fastener, one associated with a respective one of each of the LED's.

5. The assembly of claim 1 including at least one LED associated with each finger of the hand.

6. The assembly of claim 1 wherein at least one of the LED's is colored.

7. The assembly of claim 1 wherein the battery connector has male and female snap connectors to connect with corresponding female and male snap connectors of a battery.

8. The assembly of claim 1 wherein the circuit includes a switch.

9. The assembly of claim 8 wherein the female connector of the battery snap connector has a generally circumferential lip having a lip gap to permit the male snap connector to radially disengage from the female snap connector of the battery connector, thereby forming the switch.

10. The assembly of claim 8 wherein the LED's, the battery connector, the conductor and the switch are mounted on a printed circuit board.

11. A hands free signaling system comprising:
a glove adapted to be placed over a hand;
a circuit including a plurality of LED's, a battery connector and a conductor electrically coupling the battery connector to the LED's; and
a connecting device for removably connecting the circuit to the glove.

12. The system of claim 11 wherein the glove includes open finger tips.

13. The assembly of claim 11 wherein the connecting device comprises a first side of a hook and loop fastener.

14. The assembly of claim 13 wherein the connecting device further comprises a second side of the hook and loop fastener secured to a glove adapted to be placed over the hand.

15. The assembly of claim 14 including a plurality of the second sides of the hook and loop fastener, one associated with a respective one of each of the LED's.

16. The assembly of claim 11 including at least one LED associated with each finger of the hand.

17. The assembly of claim 11 wherein at least one of the LED's is colored.

18. The assembly of claim 11 wherein the circuit includes a switch.

19. The assembly of claim 11 wherein the battery connector has male and female snap connectors to connect with corresponding female and male snap connectors of a battery.

20. The assembly of claim 19 wherein the female connector of the battery snap connector has a generally circumferential lip having a lip gap to permit the male snap connector to radially disengage from the female snap connector of the battery connector, thereby forming the switch.

21. The assembly of claim 18 wherein the LED's, the battery connector, the conductor and the switch are mounted on a printed circuit board.

22. The assembly of claim 20 including an electrical insulator at ends of the circumferential lip.
